(19) United States
(12) Patent Application Publication
(10) Pub. No.: US 2013/0197990 A1
(43) Pub. Date: Aug. 1, 2013

(54) System and method for the production, distribution, redemption and tracking of purchase offers via social promotion performed over electronic network systems

(71) Applicants: Aleksandar Marko Velkoski, Chicago, IL (US); Anthony Michael Rubin, Chicago, IL (US)

(72) Inventors: Aleksandar Marko Velkoski, Chicago, IL (US); Anthony Michael Rubin, Chicago, IL (US)

(21) Appl. No.: 13/372,407

(22) Filed: Feb. 13, 2012

Related U.S. Application Data
(60) Provisional application No. 61/592,676, filed on Jan. 31, 2012.

(51) Int. Cl. G06Q 30/02

(52) U.S. Cl. 705/14.36

(57) ABSTRACT

An automated social promotion platform that accepts member registration, social network authentication and social promotion via electronic network systems enabling members to redeem benefits of purchase offers. The platform accepts merchant registration and social network authentication via electronic network systems authorizing merchants to consolidate production, distribution, redemption and tracking of purchase offers. When member socially promotes purchase offer, the system and method examines social promotion activity to determine if the member fulfilled the requirements for purchase offer participation and/or redemption. If the system determines that the member fulfilled the requirements for purchase offer participation and/or redemption, then the member is qualified to participate in and/or redeem purchase offers.

### CROSS-REFERENCE TO RELATED APPLICATIONS

This application claims the benefit of U.S. Provisional Patent Application No. 61/592,676 filed on Jan. 31, 2012. This prior application is incorporated herein by reference in its entirety.

### REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### BACKGROUND OF THE INVENTION

### I. Field of the Invention

The disclosed invention relates generally to a system and method for managing purchase offers performed over electronic network systems. More specifically, the invention relates to a system and method for managing the production, distribution, redemption and tracking of purchase offers to buyers via the social promotion of said offers to social networks over electronic network systems. Purchase offers include promotions such as price discounts, bonuses, trials, giveaways, auctions, sweepstakes, contests, loyalty benefits and the like.

### II. Description of Related Art

Purchase offers are typically provided to consumers via mediums in which merchants (sellers) can most efficiently reach target consumers (buyers). Historically, these mediums included static print advertisements, billboards, store displays, and direct mail. However, over time disruptive technology (radio, television, the Internet, etc.) advanced the production, distribution, redemption and tracking of purchase offers. Essentially, disruptive technology brought reform to the principle means by which merchants most efficiently communicated with consumers.

Today, disruptive technology exists in social networking. Not surprisingly, social networking has spawned a number of esteemed systems for merchants (e.g. group shopping systems, recommendation systems, social shopping systems, etc.). However, these systems are not adequate for specifically addressing advancement in the production, distribution, redemption and tracking of purchase offers in the social context over electronic network systems.

For instance, in current practice these systems rely on what is known about the consumer's social environment to deliver targeted advertisements to consumers. However, this does not specifically address a comprehensive social solution that integrates the consumer with purchase offers. Hence, the inventors are interested in the progression of purchase offers via consumer social promotion over electronic network systems. Unlike other systems, the inventors' solution integrates consumer social promotion with purchase offer participation and redemption, and restructures purchase offer production, distribution, redemption and tracking in a more comprehensive and social context.

### III. Referenced U.S. Patent Documents

| Patent Application Number | Inventors |
|---|---|
| 20080189169 | Turpin, Martin, et al, |
| 20080154739 | Kalaboukis |
| 20080147482 | Messing, Bill, et al. |
| 20090018918 | Moneypenny, Felina, et al. |
| 20090171748 | Aven, Lee, et al. |
| 20090164323 | Byrne |
| 20090192871 | Deacon, David, et al. |
| 20090222302 | Higgins, William, et al. |
| 20090221312 | Franklin |
| 20100125490 | Kiciman, Mehmet, et al. |
| 20100217670 | Reis, Davi, et al. |
| 20120010939 | Krishnamoorthy, Prabhakaran, et al. |
| 20110125605 | Chatter, Mukesh, et al. |
| 20110004525 | Byrne |
| 20110184792 | Butcher, Thomas, et al. |
| 20110264522 | Chan, Kenneth, et al. |
| 20110270719 | Hollars, Anthony Scott, et al. |
| 20110246270 | Krywolt |

### BRIEF SUMMARY OF THE INVENTION

The disclosed invention relates generally to a system and method for managing purchase offers performed over electronic network systems (e.g. the Internet). More specifically, the invention relates to a system and method for managing the production, distribution, redemption and tracking of purchase offers to buyers via the social promotion of said offers over electronic network systems. Purchase offers include promotions such as price discounts, bonuses, trials, giveaways, auctions, sweepstakes, contests, loyalty benefits and the like.

In the system and method social promotion is a central prerequisite condition for purchase offer participation and redemption. Merchants register and access system via merchant portal to define sensitive merchant and purchase offer characteristics, including but not limited to name, address, phone number, purchase offer location (if applicable), purchase offer type, consumer participation permitted, degree of social promotion required for offer redemption at the consumer-level, length of time of offer availability as well as other sets of restrictions.

The system distributes purchase offer to consumers via a member portal. Members utilize system to promote purchase offer to consumers in their social network. The system identifies the degree of member social promotion of a purchase offer via electronic network systems and ensures that this activity is no less than the degree required for purchase offer participation and redemption. Once conditions are met, system allows consumer to elect (but does not require) to redeem said purchase offer. At minimum, the system requires one point social promotion for redemption of any purchase offer. As illustrated in FIG. 1.1, one point social promotion occurs when a member promotes purchase offer to consumers in their social network. This is considered a level one stimulus ripple. In this case, consumers in the member's social network (in-network consumers) are able to view the purchase offer but are not required to promote purchase offer to peers in their social network (out-of-network consumers).

Furthermore, as previously specified merchants use the system to define the degree of social promotion required from the member. This may be above one point social promotion. For example, as illustrated in FIG. 1.2, two point social promotion comprises characteristics of one point social promotion, but also requires that one consumer in member's social network promote purchase offer to peers in their social network. Hence, two point social promotion comprises a level one stimulus ripple as well as a level two in-network ripple. In this case, level three out-of-network peers are able to view the purchase offer but do not promote purchase offer to peers in their social network.

Similarly, as illustrated in FIG. 1.3a and 1.3b, three point social promotion comprises characteristics of two point social promotion, but requires either {1} one peer in the member's peer's social network promote purchase offer to peers in their social network or {2} one additional peer in member's social network promote purchase offer to peers in their social network. Therefore, three point social promotion comprises a level one stimulus ripple, a level two in-network ripple, and either {1} a level three out-of-network ripple or {2} one additional level two in-network ripple.

If both {1} and {2} mentioned above occur, then four point social promotion results (e.g. this would be one way to achieve four point social promotion). Simply put, the defining characteristic of the ripple effect is that it can be efficiently and effectively traced back to any promoting member through a tree-like graph. In this system the available degrees of social promotion are bound only by aggregate social network participation over electronic network systems. At the merchant level, social promotion is bound by the same characteristics; although as previously specified the count of members that can redeem purchase offer is restricted by count of member participation permitted by merchant. Finally, at the member-level the degree of social promotion spans beyond the depth of member's social network. Hence the opportunity for social promotion increases exponentially with each ripple, which in turn intensifies the vastness of the reach of the purchase offer. The result is an unprecedented, integrated, measureable, word-of-mouth ripple effect that spans beyond member's social environment.

A better understanding of the substance, advantages, features, properties and relationships of the invention will be obtained from the following detailed description and accompanying drawings which set forth an illustrative embodiment and which are indicative of the various ways in which the principles of the invention may be employed.

### BRIEF DESCRIPTION OF THE SEVERAL VIEWS OF THE DRAWING(S)

In order to improve the understanding of the disclosed invention, the following drawings have been furnished in which:

FIG. 1.1 illustrates an exemplary one point social promotion structure;

FIG. 1.2 illustrates an exemplary two point social promotion structure;

FIG. 1.3a through 1.3b illustrates an exemplary three point social promotion structure;

FIG. 2.1 illustrates an exemplary electronic network system in which principles of the disclosed invention can be employed;

FIG. 3.1a through 3.1b illustrates an exemplary platform map for use in connection with disclosed invention;

FIG. 4.1a through 4.1b illustrates exemplary aggregate ripple processing;

### DETAILED DESCRIPTION OF THE INVENTION

While not a prerequisite condition, the system and method disclosed seeks to maximize the prospect of utilizing social promotion, social networks and electronic network systems together to advance the production, distribution, redemption and tracking of purchase offers in the social context. This is achieved through the construction and implementation of an extensive and steadfast platform that improves the way in which merchants and consumers communicate. Both merchants and consumers are expected to derive value from this invention. They are expected to do so through an innovative and consolidated approach that integrates social promotion with social networks and electronic network systems to intensify consumer demand for products and services, increase competition among merchants and ultimately improve incentives for consumers.

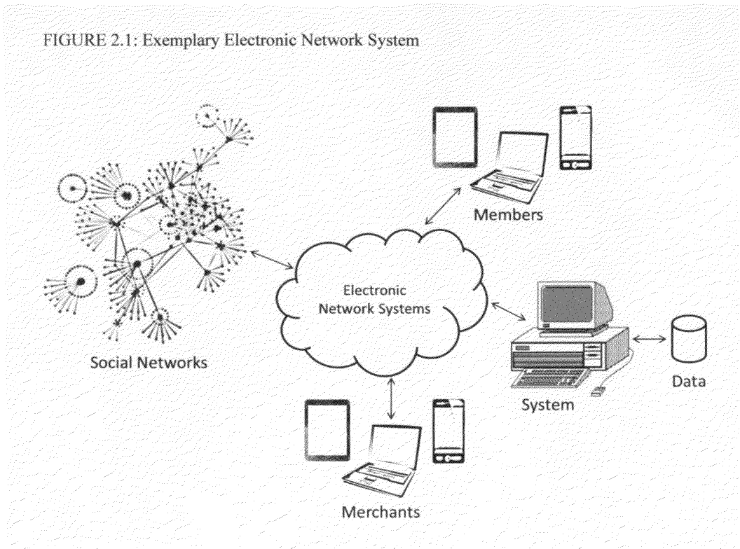

From a technological perspective, it should be noted that this invention comprises numerous electronic mechanisms and system arrangements. One embodiment is illustrated in FIG. 2.1. This may include: a consumer computer and/or laptop, a merchant computer and/or laptop, a consumer smart phone, a merchant smart phone, a consumer tablet, a merchant tablet, other hand-held devices, minicomputers, mainframe computers, applications, programs, servers, websites and associated databases. However, it should be understood by anyone skillful in the art that many different components, devices and system arrangements may be utilized with this invention. Therefore, this invention should not be intended to be limited to any particular type of computing device or arrangement set forth in this text for illustrative and descriptive purposes.

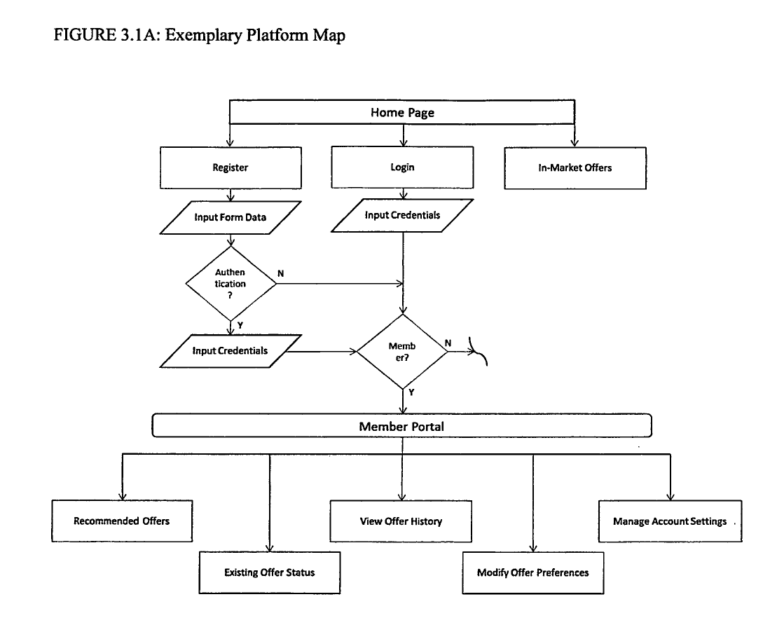

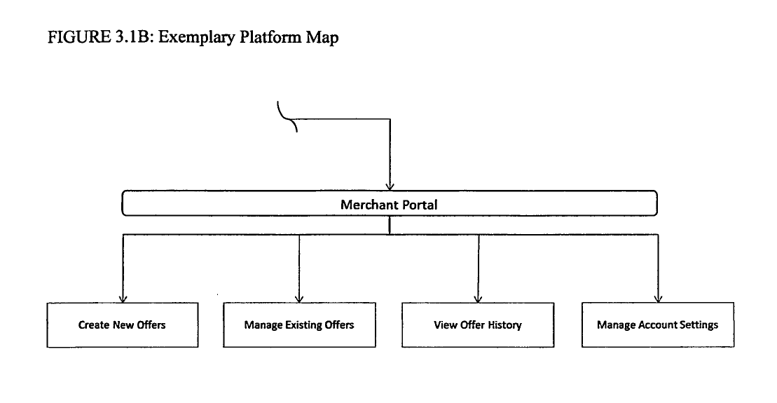

The system and method is designed to be foremost in the production, distribution, redemption and tracking of purchase offers via social promotion over electronic network systems. One embodiment of the platform is illustrated in FIG. 3.1a through 3.1b. There are two main types of users of the platform: consumers and merchants. Within the consumer type, there are two categories of users: anonymous and members. Generally speaking, anonymous consumers are restricted to viewing content and cannot participate in purchase offers or purchase offer redemption. However, members utilize the platform in order to search for and redeem valuable purchase offers, maximize personal and financial utility, support preferred brands, promote purchase offers with peers, and the like. Correspondingly, merchants utilize the platform in order to increase demand for products and services, improve brand awareness, measure marketing effectiveness, manage purchase offers, and so forth. Purchase offers include promotions such as price discounts, bonuses, trials, giveaways, auctions, sweepstakes, contests, loyalty benefits and the like.

As previously described, in order to come to be eligible to participate consumers must become members. This occurs through one of two methods: a proprietary consumer registration solution or social network authentication. The proprietary consumer registration method will require name, city or zip code, e-mail address and password. After proprietary consumer registration is complete, the consumer's ID and password is securely stored in a database and a confirmation e-mail is delivered to the consumer. In contrast, the social network authentication method will require consumer's existing login credentials for applicable social networks. Authentication procedures are provided by social networks and are integrated with the platform. Consumers select applicable social networks to synchronize with the platform and submit the required electronic forms for each network. After authentication is completed, a unique consumer ID and randomized password is automatically generated for the consumer and stored in a database, and a confirmation e-mail is delivered to the consumer. This will allow user to login using platform credentials or credentials administered by social network authentication. Irrespective of the registration solution, social network authentication is an important step for the consumer. This is due to the fact that in order to redeem purchase offers the consumer must socially promote said offers to peers in their social network. In one embodiment, social network authentication is not required and a proprietary social environment is made available so that the member can fully participate in and take advantage of the platform.

In the preferred structure, upon member registration a unique member module is created. This is also referred to as the member portal. The member portal may comprise of the following: Recommended Offers—this section will provide member with a list of recommended offers based on combination of defined member rules and purchase offer recommendations. Existing Offers Status—this section will display pending offers and metrics related to the status of those offers. View Offers History—this section will display metrics and other important information regarding purchase offers that the member has historically viewed, promoted and redeemed. Modify Offer Preferences—this section will allow the member to add or update purchase offer preferences based on offer categories, types, characteristics as well as other material. Manage Account Settings—this section will allow the member to enter physical address, add or update e-mail addresses, change password, modify privacy settings, deactivate account and manage a variety of other account related tasks.

In regard to merchants, in order to come to be eligible to participate merchants must become partners. This occurs though a proprietary merchant registration solution. This solution is distinct from the consumer registration solution. At minimum, merchant registration will include both owner (authorized representative) and merchant detail. Owner detail will include name, address, phone number, e-mail address and password. Merchant detail will include merchant legal name, doing business as name (if different than legal name), federal tax identification number, corporate address, phone number, e-mail address and website (if applicable). Merchant registration will also provide the option for social network authentication. Authentication procedures are provided by social networks and are integrated with the platform. Merchants select applicable social networks to synchronize with platform and submit the required electronic forms for each network. Once registration and authentication is complete, a unique merchant ID and password is created and stored in a database, and a confirmation e-mail is sent to the merchant. In one embodiment, social network authentication is not required and a proprietary social environment is made available so that the merchant can fully participate in and take advantage of the platform.

In the preferred structure, upon merchant registration a unique merchant module is created. This is also referred to as the merchant portal. The merchant portal may comprise of the following: Create New Offers—this section will allow the merchant to develop a new offer for a product or service as well as review recommended offer submissions. Manage Existing Offers—this section will allow the merchant to manage existing offers. View Offer History—this section will display metrics and other important information regarding purchase offers that the merchant historically provided to consumers. Manage Account Settings—this section will allow the merchant to update physical address, add or update e-mail addresses, change password, modify privacy settings, deactivate account and manage a variety of other account related information.

To provide a unified and comprehensive system for managing the production and distribution of purchase offers, merchants operate within the dedicated merchant portal. In one embodiment of purchase offers, merchants utilize the merchant portal to select a product or service type for which they intend to provide a price discount. Merchants enter the title of the offer, a brief headline description, a summary description and information related to the rules and restrictions of the offer. Furthermore, merchant enters the original value of the product or service, discounted price or percent, time left to participate in social promotion and offer valid through date. Merchant enters doing business as name, address and phone number for each location in which the offer will be valid. Finally, merchant identifies the degree of social promotion required by member in order for purchase offer redemption. In another embodiment of purchase offers, merchants utilize the merchant portal to establish an auction. Merchants enter the title of the auction, a brief headline description, a summary description and information related to the rules and restrictions of the auction. Furthermore, merchant enters the value of the product or service, a preferred offer price and the time left to participate in social promotion. Finally, merchant identifies the degree of social promotion required by member in order for purchase offer participation. It should be understood by anyone skillful in the art that this invention is not limited to these embodiments. This invention includes other types of purchase offers including but not limited to those previously described.

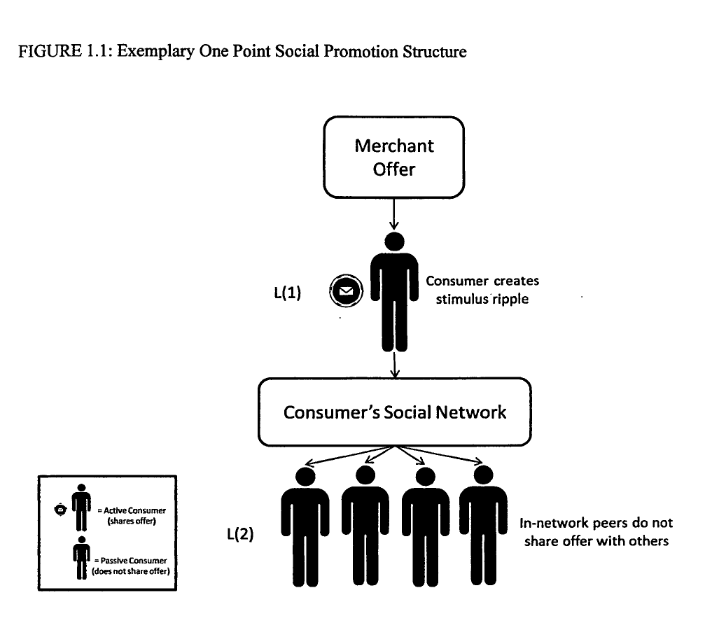

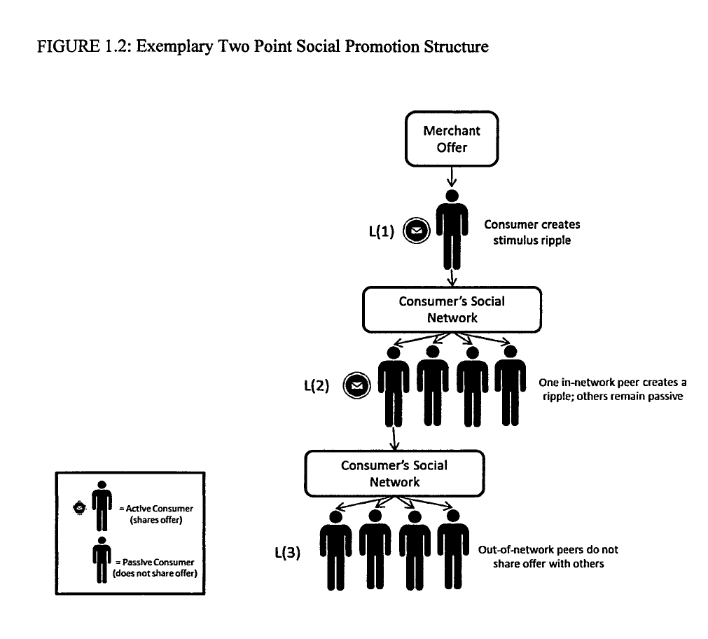

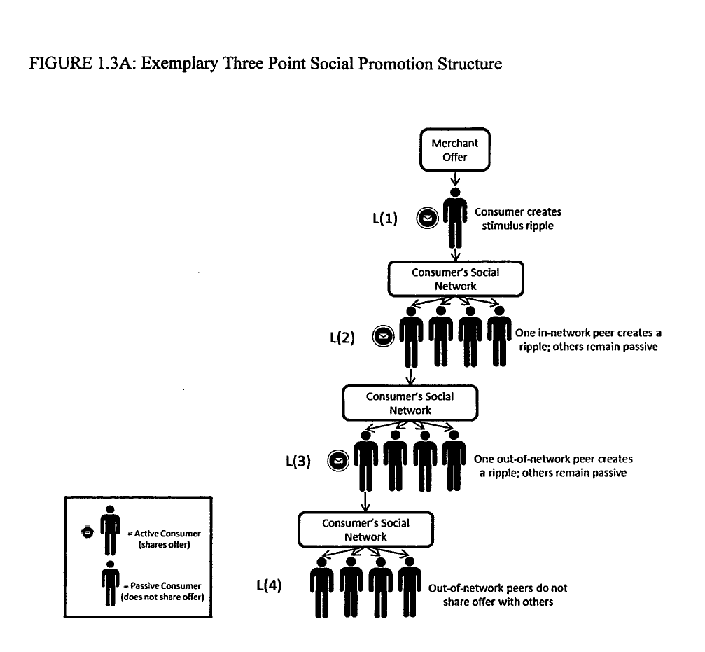

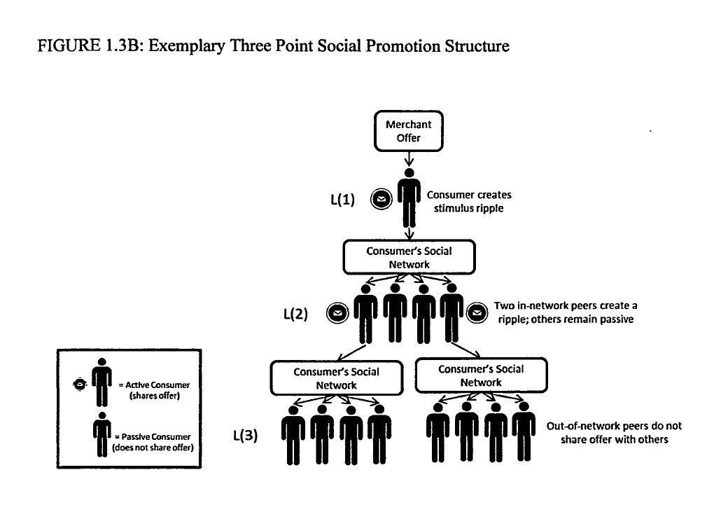

At minimum, the system requires one point social promotion for redemption of any purchase offer. As illustrated in FIG. 1.1, one point social promotion occurs when a member promotes purchase offer to peers in the member's social network. This promotion is considered a level one stimulus ripple. In this case, peers in member's social network (in-network consumers) are able to view the purchase offer but are not required to promote purchase offer to peers in their social network (out-of-network consumers). It is important to note that the degree of social promotion may be above one point social promotion. For example, as illustrated in FIG. 1.2 two point social promotion comprises characteristics of one point social promotion, but also requires that one peer in member's social network promote purchase offer to peers in their social network. Hence, two point social promotion comprises a level one stimulus ripple as well as a level two in-network ripple. In this case, level three out-of-network peers are able to view the purchase offer but do not promote purchase offer to peers in their social network. Similarly, as illustrated in FIG. 1.3a and 1.3b, three point social promotion comprises characteristics of two point social promotion, but requires either {1} one peer in the member's peer's social network promote purchase offer to peers in their social network or {2} one additional peer in member's social network promote purchase offer to peers in their social network. Therefore, three point social promotion comprises a level one stimulus ripple, a level two in-network ripple, and either {1} a level three out-of-network ripple or {2} one additional level two in-network ripple. If both {1} and {2} mentioned above occur, then four point social promotion results. This social promotion structure is for illustrative purposes and can span beyond levels described.

Getting back to purchase offer distribution, the system electronically distributes purchase offers to platform participants. In order to maximize efficiency, effectiveness, functionality and value the system provides varying levels of purchase offer distribution:

Level one—in one embodiment the system distributes purchase offers to merchant's existing purchase offers page as well as applicable consumer-facing purchase offer category pages. If a member selects to track the merchant providing the offer or specific purchase offer categories, types or characteristics provided by merchant, then the system also distributes purchase offer alert to member via text message, inbox message, e-mail message or other similar methods chosen by member. In the case of merchant social network authentication, the purchase offer is also distributed to merchant's social network.

Level two—in one embodiment the system distributes purchase offers to merchant's existing purchase offers page as well as applicable consumer-facing purchase offer category pages. However, in order to improve visibility the purchase offer is featured more prominently on applicable purchase offer category pages. If a member selects to track the merchant providing the offer or specific purchase offer categories, types or characteristics provided by merchant, then the system also distributes purchase offer alert to member via text message, inbox message, e-mail message or other similar methods chosen by member. In the case of merchant social network authentication, the purchase offer is also distributed to merchant's social network.

Level three—in one embodiment the system distributes purchase offers to merchant's existing purchase offers page, applicable purchase offer category pages and the main homepage of the website. Additionally, in order to improve visibility the purchase offer is featured more prominently on applicable purchase offer category pages. If a member selects to track the merchant providing the offer or specific purchase offer categories, types or characteristics provided by merchant, then the system also distributes purchase offer alert to member via text message, inbox message, e-mail message or other similar methods chosen by member. In the case of merchant social network authentication, the purchase offer is also distributed to merchant's social network.

Level four—in one embodiment the system distributes purchase offers to merchant's existing purchase offers page, applicable purchase offer category pages and main homepage of the website. Additionally, in order to improve visibility the purchase offer is featured more prominently on applicable purchase offer category pages as well as the main homepage of the website. If a member selects to track the merchant providing the offer or specific purchase offer categories, types or characteristics provided by merchant, then the system also distributes purchase offer alert to member via text message, inbox message, e-mail message or other similar methods chosen by member. In the case of merchant social network authentication, the purchase offer is also distributed to merchant's social network.

To provide a unified and comprehensive system for managing the redemption and tracking of purchase offers, members operate within the member portal. Members navigate to purchase offers through one or a combination of the following methods: browse the homepage and/or specific categories, types or characteristics of purchase offers, browse recommended offers, search for participating merchants, search for keywords in the title, headline description, summary description, rules and restrictions, original value, discount percent, time left to participate in social promotion and/or valid through date of the offer. In addition, members navigate to purchase offers via external links and sources. These links and sources may or may not be generated by the system. In one embodiment, member searches for price discounts provided by merchants. Once an interested purchase offer is identified, member selects the offer for more detailed review. The member is redirected to purchase offer detail page, which includes an inactivated purchase offer redemption certificate. In order to active purchase offer redemption certificate member must socially promote purchase offer to the degree required for that offer. Member does so by clicking on a social promotion link, which automatically distributes purchase offer to peers in applicable social networks as well as on the member's page (anonymous consumers do not have the capability to promote offers). This initiates a ripple effect for said purchase offer.

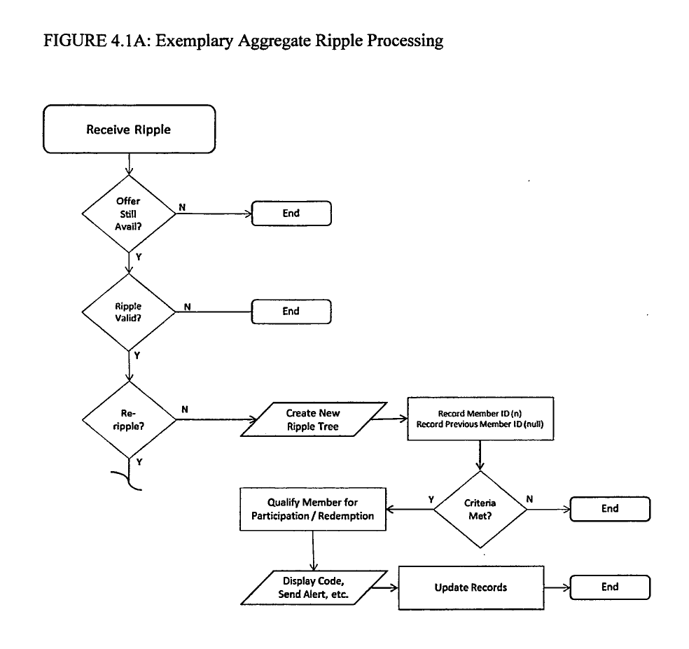

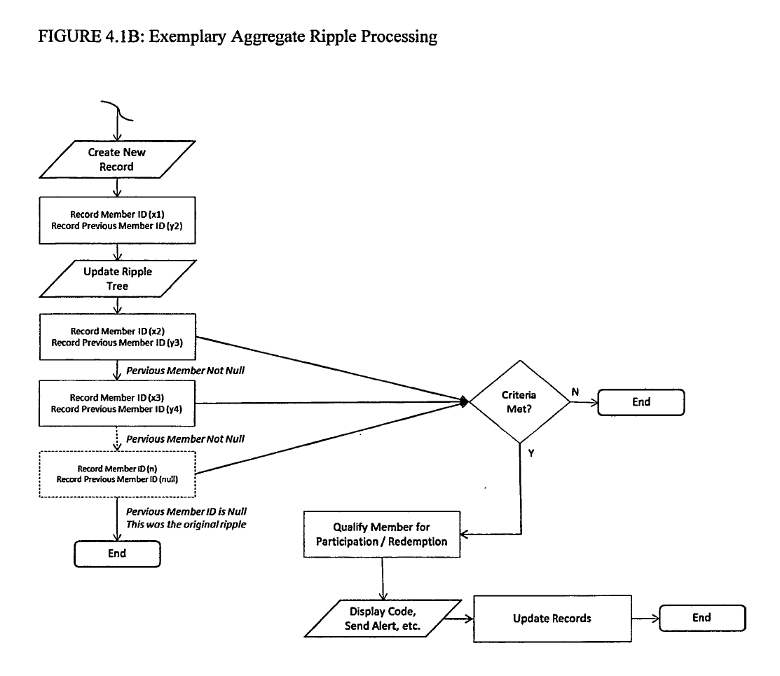

As FIG. 4.1a through 4.1b illustrates, when a promotion occurs the system creates a record of the promotion in a database. Each time a member attempts to promote a purchase offer the system ensures that the member promoting the purchase offer has not previously promoted the offer to their social networks. If the offer was previously promoted by the member, then the promotion will be invalid and will not occur. If a peer in member's social network is also a member and re-promotes the offer, the system does a similar check to ensure that the peer has not previously promoted the offer. If the peer has previously promoted the offer, then the system will similarly not allow the promotion to occur. However, if the peer has not previously promoted the offer then the system creates a record of the promotion along with the previous promoting member's ID in a database. If the peer was not a member but an anonymous consumer then the peer would be redirected to the member registration and/or authentication process previously described. If peer is not a member and chooses to disregard registration and/or authentication, then the system will not allow the promotion to be executed. Each time a member promotes an offer the system checks to determine whether or not members for that specific purchase offer have met the requisite condition for participation or redemption. If so, then the participation is authorized or redemption certificate is activated for those members. If not, participation continues to be restricted and redemption certificate remains inactive. This will continue to hold true until the member meets the requisite conditions for the purchase offer or until the purchase offer redemption cycle expires.

In another embodiment, member searches for auctions provided by merchants. Once an interested auction is identified, member selects the offer for more detailed review. The member is redirected to the purchase offer detail page, which includes an inactivated participation code. In order to activate the participation code member must socially promote purchase offer to the degree identified by the merchant. Member does so by clicking on a social promotion link, which automatically distributes purchase offer to peers in applicable social networks as well as on the member's page. This initiates a ripple effect for said offer. When member meets the requisite criteria the participation code is activated for the member. The member can then participate in the auction by placing a bid for the product or service. It should be understood by anyone skillful in the art that this invention is not limited to the embodiments described. Also, this invention includes other embodiments of purchase offers including but not limited to those hitherto described.

Furthermore, as previously noted, when member meets the requisite criteria for a purchase offer then participation is authorized and/or redemption certificate becomes activated. When redemption certificate becomes activated a unique code is created, associated with the member and is passed to the merchant via the merchant portal for tracking and retrieval purposes. When member clicks on the redemption certificate he is migrated to a redemption page. The redemption page is automatically saved in the member's existing offer status page. This page can be printed as a hard copy and taken to participating merchant for offer retrieval or the page can be shown directly to the merchant via an applicable electronic device that is connected to a network. The member may also load the page on applicable electronic mobile devices at any time when the member is connected to a network and then access it on the device at a later time even if the device is not connected to a network at that time.

It should be understood by those with skill in the art that the specific platform, pages, modules and system arrangements provided in the aforementioned embodiments may change and specific functionality may be removed, modified or added. Accordingly, the particular arrangement disclosed is meant to be for illustrative purposes only and should not be considered limiting to the scope of the invention which is to be given the full breadth of the appended claims and any equivalents thereof.

1. A method for permitting members to socially promote purchase offers to redeem benefits associated with promotions, the method comprising: accepting member registration, social network authentication and social promotion via electronic network systems enabling members to redeem benefits of purchase offers; accepting merchant registration and social network authentication via electronic network systems authorizing merchants to consolidate production, distribution, redemption and tracking of purchase offers; storing registration, authentication, behavioral, social network, purchase offer and social promotion activity in a database connected with electronic network systems; accepting merchant purchase offer submissions via electronic network systems; tracking registration, authentication, behavioral, social network, purchase offer and social promotion activity; recommending purchase offers to members; recommending purchase offer submissions to merchants; determining whether member social promotion behavior meets requirements for purchase offer; clearing participation restrictions for purchase offers for which member social promotion behavior meets requirements; releasing redemption certificate associated with purchase offers for which member social promotion behavior meets requirements; distributing redemption certificate associated with purchase offers to applicable member and merchant.

2. The method described in claim 1, including providing each member with a member portal to manage the identification, social promotion, redemption and tracking of purchase offers.

3. The method described in claim 1, including providing each merchant with a merchant portal to manage the production, distribution, redemption and tracking of purchase offers.

4. The method described in claim 1, wherein purchase offers include promotions such as price discounts, bonuses, trials, giveaways, auctions, sweepstakes, contests, loyalty benefits and the like.

5. The method described in claim 2, wherein the member portal includes existing offer status page based on member social promotion activity and purchase offer requirements.

6. The method described in claim 2, wherein the member portal includes view offer history page based on member purchase offer participation and redemption activity.

7. The method described in claim 2, wherein the member portal includes modify offer preferences page based on member purchase offer preferences.

8. The method described in claim 7, wherein the purchase offer preferences include identifying purchase offer categories, types and characteristics designated by member.

9. The method described in claim 7, wherein the purchase offer preferences include identifying merchant characteristics designated by member.

10. The method described in claim 2, wherein the member portal includes recommended offers based on member social promotion activity and purchase offer preferences, all stored in a database.

11. The method described in claim 10, wherein the recommendations include identifying purchase offer categories, types and characteristics from which member has previously promoted.

12. The method described in claim 10, wherein the recommendations include identifying purchase offer categories, types and characteristics from which peers in member's social network have previously promoted.

13. The method described in claim 10, wherein the recommendations include identifying social promotion activity for other members in which member has elected to observe.

14. The method described in claim 10, wherein the recommendations include identifying merchants that provide similar categories, types and characteristics of purchase offers.

15. The method described in claim 10, wherein the recommendations include identifying merchants and merchant characteristics from which member has elected to observe.

16. The method described in claim 15, wherein the recommendations include identifying merchant purchase offer submission categories, types and characteristics.

17. The method described in claim 3, wherein merchant portal includes view offer history page based on merchant purchase offer submissions.

18. The method described in claim 3, wherein merchant portal includes manage existing offers page based on in-market merchant purchase offers.

19. The method described in claim 3, wherein merchant portal includes create new offers page based on merchant preferences and recommended offer submissions.

20. The method described in claim 19, wherein merchant preferences include identifying purchase offer categories, types and characteristics designated by merchant.

21. The method described in claim 19, wherein recommended offer submissions are based on member social promotion activity, purchase offer preferences and redemption behavior, all stored in a database.

22. The method described in claim 19, wherein recommendations include identifying social promotion activity and redemption behavior for those members that have viewed or redeemed merchant offers or have elected to monitor merchant.

23. The method described in claim 19, wherein recommendations include identifying social promotion activity and redemption behavior for peers in member's social network for members that have viewed or redeemed merchant offers or have elected to monitor merchant.

24. The method described in claim 19, wherein recommendations include identifying social promotion activity and redemption behavior for those members that have viewed or redeemed merchant offers or have elected to monitor similar merchants.

25. The method described in claim 19, wherein recommendations include identifying purchase offer categories, types and characteristics from which similar merchants have provided.

26. The method described in claim 25, wherein recommendations include identifying purchase offer categories, types and characteristics for submissions by merchants in similar proximity.

27. A system for permitting members to socially promote purchase offers to redeem benefits associated with promotions, the system comprising: a server system, processing logic, online platform and modules accepting member registration, social network authentication and social promotion via electronic network systems enabling members to redeem benefits of purchase offers, further accepting merchant registration and social network authentication via electronic network systems authorizing merchants to consolidate production, distribution, redemption and tracking of purchase offers; a non-transitory computer-readable storage medium, the storage medium storing: registration, authentication, behavioral, social network, purchase offer and social promotion activity in a database connected with electronic network systems; a merchant module configured to generate merchant purchase offers via electronic network systems; a tracking module for analyzing registration, authentication, behavioral, social network, purchase offer and social promotion activity; a recommendation module for recommending purchase offers to members; a recommendation module recommending purchase offer submissions to merchants; a redemption module for determining whether member social promotion behavior meets requirements for purchase offer, clearing participation restrictions for purchase offers for which member social promotion behavior meets requirements and releasing redemption certificate associated with purchase offers for which member social promotion behavior meets requirements; a display module for distributing redemption certificate associated with purchase offers to applicable member and merchant.

28. The system described in claim 27, wherein system is configured to provide each member with a member portal to manage the identification, social promotion, redemption and tracking of purchase offers.

29. The system described in claim 27, wherein system is configured to provide each merchant with a merchant portal to manage the production, distribution, redemption and tracking of purchase offers.

30. The system described in claim 27, wherein purchase offers include promotions such as price discounts, bonuses, trials, giveaways, auctions, sweepstakes, contests, loyalty benefits and the like.

31. The system described in claim 28, wherein the member portal is configured to provide existing offer status page based on member social promotion activity and purchase offer requirements.

32. The system described in claim 28, wherein the member portal is configured to provide view offer history page based on member purchase offer participation and redemption.

33. The system described in claim 28, wherein the member portal is configured to provide modify offer preferences page based on member purchase offer preferences.

34. The system described in claim 33, wherein the purchase offer preferences include identifying purchase offer categories, types and characteristics designated by member.

35. The system described in claim 33, wherein the purchase offer preferences include identifying merchant characteristics designated by member.

36. The system described in claim 28, wherein the member portal is configured to provide recommended offers based on member social promotion activity and purchase offer preferences, all stored in a database.

37. The system described in claim 36, wherein the recommendations include identifying purchase offer categories, types and characteristics from which member has previously promoted.

38. The system described in claim 36, wherein the recommendations include identifying purchase offer categories, types and characteristics from which peers in member's social network have previously promoted.

39. The system described in claim 36, wherein the recommendations include identifying social promotion activity for other members in which a member has elected to observe.

40. The system described in claim 36, wherein the recommendations include identifying merchants that provide similar categories, types and characteristics of purchase offers.

41. The system described in claim 36, wherein the recommendations include identifying merchants and merchant characteristics from which member has elected to observe.

42. The system described in claim 41, wherein the recommendations include identifying merchant purchase offer submission categories, types and characteristics.

43. The system described in claim 29, wherein merchant portal is configured to provide view offer history page based on merchant purchase offer submissions.

44. The system described in claim 29, wherein merchant portal is configured to provide manage existing offers page based on in-market merchant purchase offers.

45. The system described in claim 29, wherein merchant portal is configured to provide create new offers page based on merchant preferences and recommended offer submissions.

46. The system described in claim 45, wherein merchant preferences include identifying purchase offer categories, types and characteristics designated by merchant.

47. The system described in claim 45, wherein recommended offer submissions are based on member activity, purchase offer preferences and redemption behavior, all stored in a database.

48. The system described in claim 45, wherein recommendations include identifying social promotion activity and redemption behavior for those members that have viewed or redeemed merchant offers or have elected to monitor merchant.

49. The system described in claim 45, wherein recommendations include identifying social promotion activity and redemption behavior for peers in member's social network for members that have viewed or redeemed merchant offers or have elected to monitor merchant.

50. The system described in claim 45, wherein recommendations include identifying social promotion activity and redemption behavior for those members that have viewed or redeemed merchant offers or have elected to monitor similar merchants.

51. The system described in claim 45, wherein recommendations include identifying purchase offer categories, types and characteristics from which similar merchants have provided.

52. The system described in claim 51, wherein recommendations include identifying purchase offer categories, types and characteristics for submissions by merchants in similar proximity.
